(19) United States
(12) Patent Application Publication
(10) Pub. No.: US 2025/0289367 A1
(43) Pub. Date: Sep. 18, 2025

(54) APPARATUS FOR OPERATING MIRROR ASSEMBLY OF VEHICLE

(71) Applicant: SL Mirrortech Corporation, Siheung-si (KR)

(72) Inventors: Yong Hwan KIM, Siheung-si (KR); Yeong Kook CHO, Siheung-si (KR); Youngsu NAM, Siheung-si (KR)

(21) Appl. No.: 19/023,835

(22) Filed: Jan. 16, 2025

Related U.S. Application Data
(63) Continuation-in-part of application No. 18/158,292, filed on Jan. 23, 2023.

(30) Foreign Application Priority Data
Mar. 29, 2022 (KR) 10-2022-0039034
Mar. 7, 2024 (KR) 10-2024-0032681

(51) Int. Cl. B60R 1/074

(52) U.S. Cl. CPC B60R 1/074

(57) ABSTRACT

An apparatus for operating a mirror assembly of a vehicle includes a fixing member fixed to a mirror base of the vehicle; and a driving member fixed to a mirror housing of the vehicle and configured to rotate the mirror housing with respect to the fixing member by generating a driving force. A position of the mirror housing includes a first position where the mirror housing is unfolded with respect to the mirror base and a second position where the mirror housing is folded with respect to the mirror base. The driving member is configured to decrease a gap between the mirror housing and the mirror base when the mirror housing is changed from the second position to the first position, and increase the gap when the mirror housing is changed from the first position to the second position.

### CROSS-REFERENCE TO RELATED APPLICATIONS

This application is a Continuation in-part of application Ser. No. 18/158,292 filed Jan. 23, 2023, which claims priority from Korean Application No. 10-2022-0039034 filed Mar. 29, 2022. This application also claims priority from Korean Application No. 10-2024-0032681 filed Mar. 7, 2024. The aforementioned applications are incorporated herein by reference in their entireties.

### BACKGROUND

### 1. Technical Field

The present disclosure relates to a driving apparatus for a vehicle, and more particularly, to a driving apparatus for operating a mirror assembly of a vehicle that adjusts a gap between a mirror housing and a mirror base provided in the vehicle.

### 2. Description of the Related Art

Inside a vehicle, an inside mirror is installed so that a driver can observe the rear situation of the vehicle, while outside mirrors are installed on both sides of the vehicle so that the driver can observe the rear side situation of the vehicle. The driver can identify the surrounding vehicles or pedestrians, back up the vehicle, pass another vehicle, and change lanes aided by the field of view secured by the inside mirror or the outside mirrors.

Recently, in order to reduce air resistance as well as to reduce the possibility of damages caused by external impacts, a camera mirror including a camera has been applied instead of the outside mirror. Since the surrounding image of the vehicle acquired by the camera mirror is displayed through a display device inside the vehicle, the driver can easily observe the surrounding situation.

When operating a vehicle, the outside mirror or the camera mirror remains unfolded so that the driver can observe the surrounding situation. On the other hand, when the vehicle is parked or passing through a narrow space, it is necessary to fold the outside mirror or camera mirror towards the vehicle to avoid damages to the outside mirror or camera mirror or to secure the surrounding space. In such case, the driver can rotate the outside mirror or camera mirror by using an actuator or manually.

### SUMMARY

Aspects of the present disclosure provide a driving apparatus for a vehicle that allows adjusting a gap between a mirror housing and a base provided in the vehicle while folding or unfolding the mirror housing.

The technical aspects of the present disclosure are not restricted to those set forth herein, and other unmentioned technical aspects will be clearly understood by one of ordinary skill in the art to which the present disclosure pertains by referencing the detailed description of the present disclosure given below.

According to an embodiment of the present disclosure, an apparatus for operating a mirror assembly of a vehicle may include a fixing member fixed to a mirror base of the vehicle; a driving member fixed to a mirror housing of the vehicle and configured to generate a driving force to rotate the mirror housing with respect to the fixing member; and a base elastic member disposed between the fixing member and the driving member to generate an elastic force that biases the driving member away from the fixing member. A position of the mirror housing may be switchable to a first position in which the mirror housing is unfolded with respect to the mirror base or to a second position in which the mirror housing is folded with respect to the mirror base. The driving member may be configured to decrease a gap between the mirror housing and the mirror base in response to the mirror housing having been switched to the first position; and to increase the gap in response to the mirror housing being switched from the first position to the second position.

As described herein, a driving apparatus for a vehicle according to embodiments of the present disclosure may prevent or reduce wind noise by maximally decreasing a gap between a mirror housing and a mirror base during driving. Further, abrasion between the mirror base and the mirror housing may be prevented or reduced by maintaining a particular gap between the mirror base and the mirror housing when the mirror housing rotates with respect to the mirror base.

### BRIEF DESCRIPTION OF THE DRAWINGS

The above and other aspects and features of the present disclosure will become more apparent by describing in detail exemplary embodiments thereof with reference to the attached drawings, in which:

FIG. 1 illustrates a vehicle provided with an apparatus for operating a mirror housing of a vehicle according to an embodiment of the present disclosure;

FIG. 2 depicts the mirror housing of the vehicle illustrated in FIG. 1 being folded;

FIG. 3 depicts the mirror housing of the vehicle illustrated in FIG. 1 being unfolded;

FIG. 4 depicts the mirror housing of the vehicle illustrated in FIG. 1 being folded in an opposite direction;

FIG. 5 illustrates a space formed between the mirror base and the mirror housing;

FIG. 6 illustrates the mirror housing disposed proximate to the mirror base;

FIG. 7 depicts the mirror housing being folded;

FIG. 8 is a perspective view of a driving apparatus for a vehicle according to an embodiment of the present disclosure;

FIG. 9 is an exploded perspective view of the driving apparatus according to an embodiment of the present disclosure;

FIG. 10 is a front view of a main cover of the driving apparatus according to an embodiment of the present disclosure;

FIG. 11 is a perspective view of a base cover of the driving apparatus according to an embodiment of the present disclosure;

FIG. 12 depicts an operation of the main cover with respect to the base cover of the driving apparatus according to an embodiment of the present disclosure;

FIG. 13 is a perspective view of a fixing member of the driving apparatus according to an embodiment of the present disclosure;

FIG. 14 is an exploded perspective view of a driving member of the driving apparatus according to an embodiment of the present disclosure;

FIG. 15 is a perspective view of a drive body of the driving apparatus according to an embodiment of the present disclosure;

FIG. 16 is a bottom perspective view of the drive body of the driving apparatus according to an embodiment of the present disclosure;

FIG. 17 depicts a coupling relationship between the drive body and the fixing member of the driving apparatus according to an embodiment of the present disclosure;

FIG. 18 is a bottom perspective view of a driving gear of the driving apparatus according to an embodiment of the present disclosure;

FIG. 19 is a bottom view of the driving gear of the driving apparatus according to an embodiment of the present disclosure;

FIG. 20 is a perspective view of a detent member of the driving apparatus according to an embodiment of the present disclosure;

FIG. 21 is a top plan view of the detent member of the driving apparatus according to an embodiment of the present disclosure;

FIG. 22 depicts a coupling relationship between the driving gear and the detent member of the driving apparatus according to an embodiment of the present disclosure;

FIG. 23 depicts a coupling relationship between the fixing member and the detent member of the driving apparatus according to an embodiment of the present disclosure;

FIG. 24 depicts a driving force of a driving motor being transmitted to the driving gear in the driving apparatus according to an embodiment of the present disclosure;

FIG. 25 depicts a first position of the mirror housing with respect to the mirror base;

FIG. 26 illustrates the inside of the driving member when the mirror housing is in the first position;

FIG. 27 depicts a relationship between the driving gear and the detent member when the mirror housing is in the first position;

FIG. 28 depicts the position of the mirror housing with respect to the mirror base being changed from the first position to a second position;

FIG. 29 depicts the support of the detent protrusion being released from a protrusion support in the driving apparatus according to an embodiment of the present disclosure;

FIG. 30 depicts the detent protrusion being supported by a bottom surface of a detent groove in the driving apparatus according to an embodiment of the present disclosure;

FIG. 31 depicts the detent protrusion abutting a guide inclined surface and a rotation blocking member in the driving apparatus according to an embodiment of the present disclosure;

FIG. 32 depicts the position of the mirror housing with respect to the mirror base being changed from the second position to the first position;

FIG. 33 depicts the detent protrusion abutting the support inclined surface of the detent groove in the driving apparatus according to an embodiment of the present disclosure;

FIG. 34 depicts the detent protrusion being supported by the protrusion support of the detent groove in the driving apparatus according to an embodiment of the present disclosure;

FIG. 35 depicts the position of the mirror housing with respect to the mirror base being changed from the first position to a third position;

FIG. 36 depicts the detent protrusion being moved to an upper surface of the detent member in the driving apparatus according to an embodiment of the present disclosure;

FIG. 37 depicts the detent member being pressed by the driving gear in the driving apparatus according to an embodiment of the present disclosure.

FIG. 38 is an exploded perspective view of a driving apparatus for a vehicle according to another embodiment of the present disclosure;

FIG. 39 depicts a base elastic member being coupled to the fixing member;

FIG. 40 is an exploded perspective view of the driving member in the driving apparatus according to an embodiment of the present disclosure;

FIG. 41 is a bottom perspective view of a drive body in the driving apparatus according to an embodiment of the present disclosure; and

FIG. 42 depicts the interior of a driving member when a mirror housing is in a second position.

### DETAILED DESCRIPTION

Hereinafter, embodiments of the present disclosure will be described with reference to the attached drawings. The merits and characteristics of the present disclosure and a method for achieving the merits and characteristics will become more apparent from the embodiments described in detail in conjunction with the accompanying drawings. However, the present disclosure is not limited to the disclosed embodiments, but may be implemented in various different ways. The embodiments are provided to complete the disclosure and to allow those skilled in the art to understand the scope of the present disclosure. The present disclosure is defined by the scope of the claims. Like reference numerals refer to like elements throughout the description of the figures.

Unless otherwise defined, all terms (including technical and scientific terms) used in the present specification may be used in a sense that can be commonly understood by those skilled in the art. In addition, the terms defined in the commonly used dictionaries are not to be too ideally or excessively interpreted unless they are specifically defined clearly.

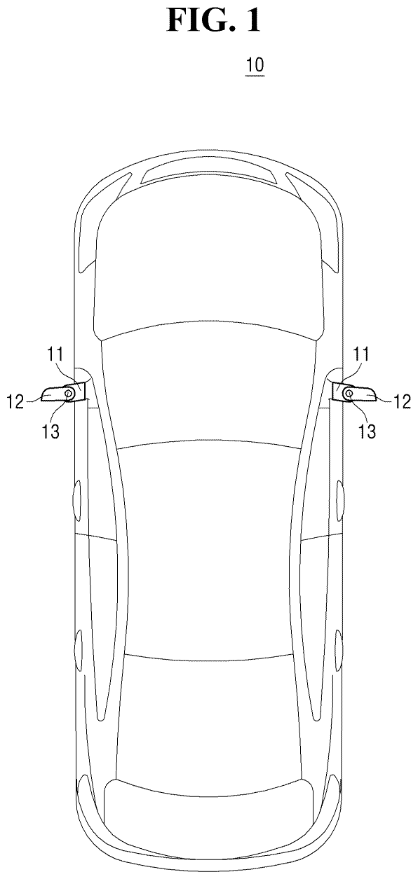

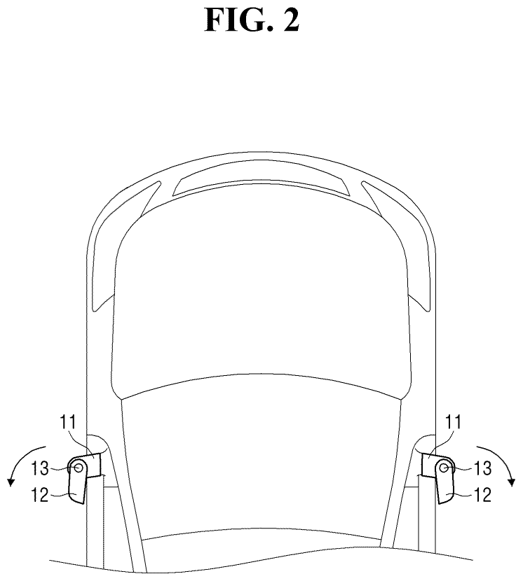

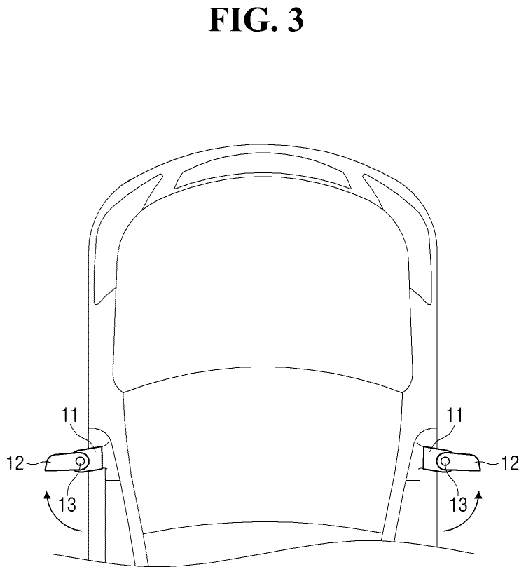

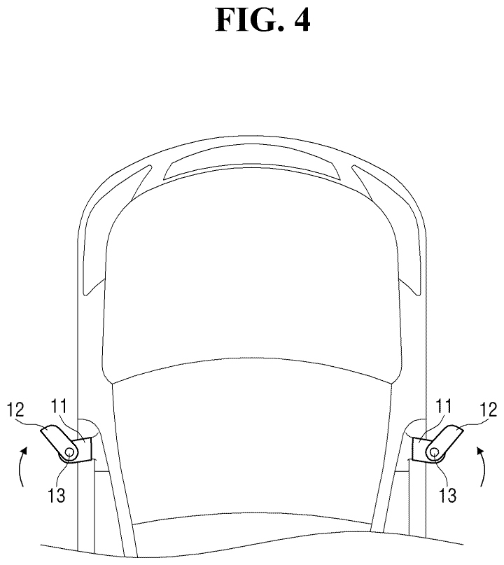

FIG. 1 illustrates a vehicle provided with an apparatus for operating a mirror assembly of a vehicle according to an embodiment of the present disclosure, FIG. 2 depicts a mirror housing of the vehicle illustrated in FIG. 1 being folded, FIG. 3 depicts the mirror housing of the vehicle illustrated in FIG. 1 being unfolded, and FIG. 4 depicts the mirror housing of the vehicle illustrated in FIG. 1 being folded in an opposite direction.

Referring to FIGS. 1 to 4, a vehicle 10 may include a mirror base 11, a mirror housing 12, and a driving apparatus 13. The mirror base 11 may be fixed to a vehicle body to support the mirror housing 12. The mirror housing 12 may provide a driver with the fields of view of the side and rear of the vehicle 10. For example, the mirror housing 12 may include at least one of mirror or an imaging device (e.g., camera). The mirror may provide reflective images of the side and rear of the vehicle 10, while the imaging device may generate photographed images of the side and rear of the vehicle 10. The photographed images generated by the imaging device may be still images or moving images.

The driver may check the fields of view of the side and rear of the vehicle 10 by referring to the reflective image provided via the mirror or the image generated by the imaging device. In order to output the image generated by the imaging device, a display means capable of outputting an image may be provided in an interior space the vehicle 10.

The driving apparatus 13 may generate a driving force and may rotate the mirror housing 12 with respect to the mirror base 11. The driving apparatus 13 may be provided in the mirror base 11 or the mirror housing 12. Hereinafter, the driving apparatus 13 provided in the mirror housing 12 will be mainly described as an example. However, the present disclosure is not limited thereto, and the driving apparatus 13 may be provided in the mirror base 11.

Referring to FIGS. 2 to 4, the mirror housing 12 may be folded or unfolded with respect to the mirror base 11. In the present disclosure, folding the mirror housing 12 means that the mirror housing 12 is retracted so that an outer end of the mirror housing 12 approaches the vehicle body, as illustrated in FIG. 2. When the vehicle 10 is parked or the vehicle 10 passes through a narrow space, the mirror housing 12 may be folded to secure a side space of the vehicle 10. In the present disclosure, unfolding the mirror housing 12 means that the mirror housing 12 is extended so that the outer end of the mirror housing 12 moves away from the vehicle body, as illustrated in FIG. 3. When driving the vehicle 10, the fields of view of the side and rear of the vehicle 10 may be provided to the driver by unfolding the mirror housing 12.

As illustrated in FIG. 4, the mirror housing 12 may be folded in a direction opposite to the folding direction illustrated in FIG. 2. When pedestrians, surrounding vehicles, or surrounding objects exert an external force on the mirror housing 12, the mirror housing 12 may be folded as illustrated in FIG. 4. This is to prevent pedestrians from being injured and/or to avoid inflicting damages to surrounding vehicles, surrounding objects, and/or to the mirror housing 12. Hereinafter, the folding direction illustrated in FIG. 4 is referred to as “reverse folding.”

Hereinafter, as illustrated in FIG. 3, a position where the mirror housing 12 is unfolded with respect to the mirror base 11 to provide the driver with the fields of view of the side and rear of the vehicle 10 is referred to as a first position, and as illustrated in FIG. 2, a position where the mirror housing 12 is folded with respect to the mirror base 11 to secure a side space of the vehicle 10 is referred to as a second position. Furthermore, as illustrated in FIG. 4, a position where the mirror housing 12 is reverse-folded to prevent damages to the surrounding objects and to the mirror housing 12 is referred to as a third position. A position of the mirror housing 12 may be changed to the first position where the mirror housing 12 is unfolded with respect to the mirror base 11 or to the second position where the mirror housing 12 is folded with respect to the mirror base 11, and may be changed to the third position by an external force.

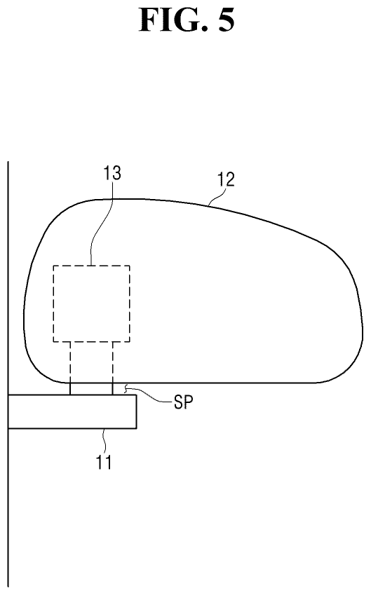

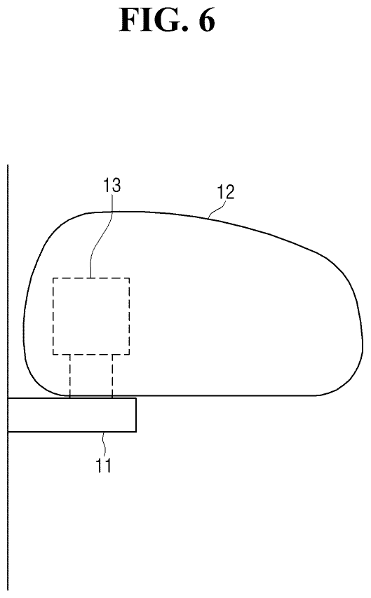

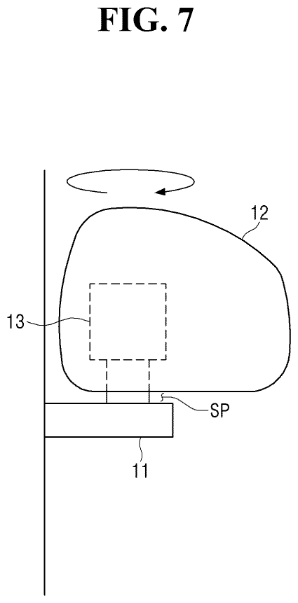

FIG. 5 depicts a space (e.g., gap) formed between the mirror base and the mirror housing, FIG. 6 depicts the mirror housing disposed proximate to the mirror base, and FIG. 7 depicts the mirror housing being folded. Referring to FIGS. 5 to 7, the mirror housing 12 may be supported by the mirror base 11.

FIG. 5 illustrates that a space SP may be formed between the mirror housing 12 and the mirror base 11. Meanwhile, when the gap SP between the mirror housing 12 and the mirror base 11 is excessively large, air may flow into the corresponding space SP during driving of the vehicle 10, which may result in wind noise.

FIG. 6 illustrates that the mirror housing 12 may be disposed in close proximity with the mirror base 11. If the mirror housing 12 rotates with the mirror housing 12 contacting the mirror base 11, abrasion or scratch may occur due to the friction between the mirror housing 12 and the mirror base 11. Accordingly, excessively large or small gap between the mirror housing 12 and the mirror base 11 is problematic because the wind noise or the abrasion may occur.

The driving apparatus 13 according to an embodiment of the present disclosure may rotate the mirror housing 12 with respect to the mirror base 11 while preventing or reducing the wind noise or the abrasion. Specifically, when the mirror housing 12 is in the first position, the driving apparatus 13 may allow the mirror housing 12 to be in close contact with the mirror base 11. In addition, as illustrated in FIG. 7, when the position of the mirror housing 12 is changed from the first position to the second position, the driving apparatus 13 may allow the mirror housing 12 to be separated (e.g., lifted) from the mirror base 11 by a certain distance. Since the mirror housing 12 rotates while being separated from the mirror base 11 by a certain distance, the occurrence of friction sound may be prevented. Furthermore, when the mirror housing 12 is disposed in the second position, since the vehicle is not driven, the space SP may be formed between the mirror housing 12 and the mirror base 11.

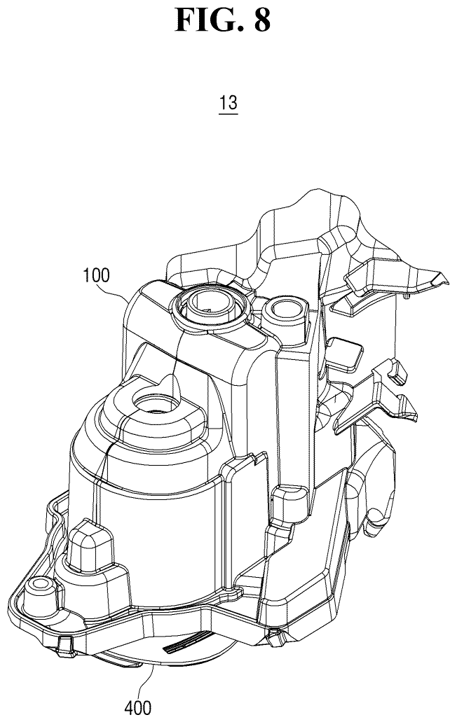

Hereinafter, the structure and function of the driving apparatus 13 according to an embodiment of the present disclosure will be described in detail with reference to FIGS. 8 to 37.

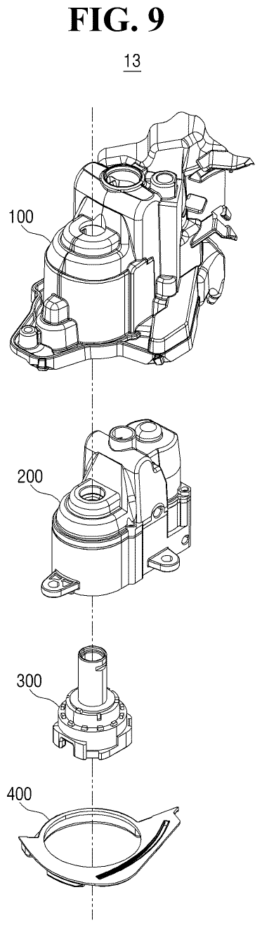

FIG. 8 is a perspective view of the driving apparatus for a vehicle according to an embodiment of the present disclosure, and FIG. 9 is an exploded perspective view of the driving apparatus according to an embodiment of the present disclosure. Referring to FIGS. 8 and 9, the driving apparatus 13 for a vehicle according to one embodiment of the present disclosure includes a main cover 100, a driving member 200, a fixing member 300, and a base cover 400.

The main cover 100 may accommodate the driving member 200 and the fixing member 300 and may be fixed to the mirror housing 12. Herein, the driving member 200 may be fixed to the main cover 100. Accordingly, the mirror housing 12, the main cover 100, and the driving member 200 may be integrally operated. For instance, the mirror housing 12, the main cover 100, and the driving member 200 may rotate simultaneously with respect to the fixed member 300 by a driving force generated from the driving member 200.

The driving member 200 may be fixed to the mirror housing 12 of the vehicle 10 and may rotate the mirror housing 12 with respect to the fixing member 300 by generating the driving force. More specifically, the driving member 200 may be fixed to the mirror housing 12 through the main cover 100, and the driving force of the driving member 200 may be transmitted to the mirror housing 12 through the main cover 100.

The driving member 200 may move the mirror housing 12 proximate to the mirror base 11 at a preset reference interval when the position of the mirror housing 12 is changed from the second position to the first position. Herein, the reference interval may include no (zero) interval. For example, the driving member 200 may bring the mirror housing 12 into close contact with the mirror base 11 in the first position of the mirror housing 12. As the mirror housing 12 is disposed proximate to the mirror base 11, the occurrence of the wind noise may be prevented or reduced.

In addition, when the position of the mirror housing 12 is changed from the first position to the second position, the driving member 200 may separate the mirror housing 12 from the mirror base 11 to an interval exceeding the reference interval. As the mirror housing 12 is separated apart from the mirror base 11, the friction or abrasion between the mirror housing 12 and the mirror base 11 may be prevented or reduced.

The fixing member 300 may be fixed to the mirror base 11 of the vehicle 10. In addition, the fixing member 300 may provide a reference of rotation for the driving member 200. In other words, the driving member 200 may be rotatably coupled to the fixing member 300 and may rotate with respect to a rotation axis of the fixing member 300.

The base cover 400 may be fixed to the mirror base 11 while sealing an opening of the mirror base 11. In addition, as described below, the base cover 400 may determine a range of rotation for the main cover 100.

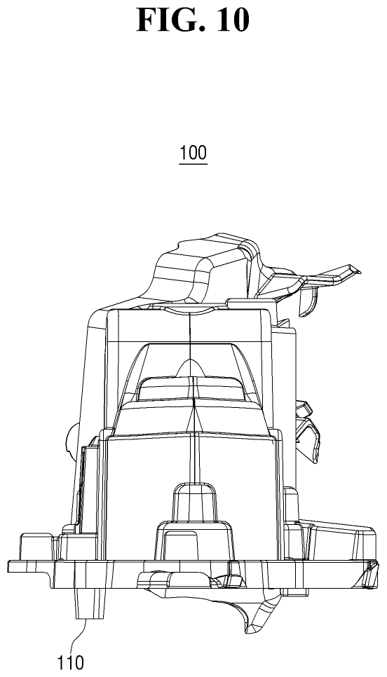

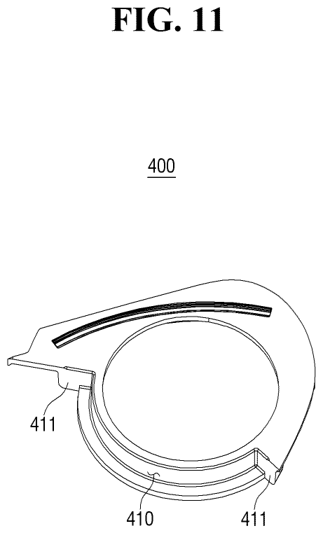

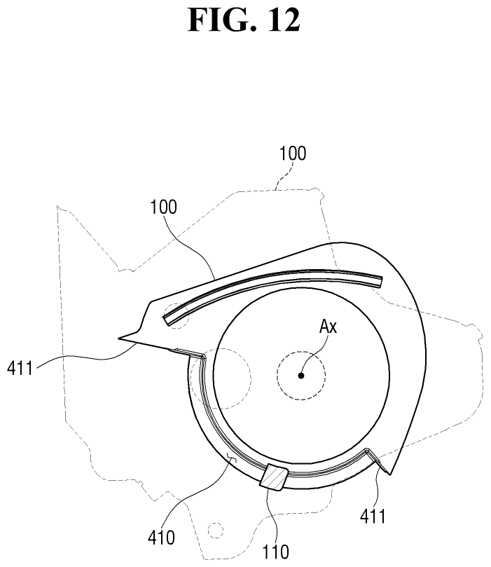

FIG. 10 is a front view of the main cover 100, FIG. 11 is a perspective view of the base cover 400, and FIG. 12 is a view explaining an operation of the main cover 100 with respect to the base cover 400. Referring to FIGS. 10 to 12, the main cover 100 may include a cover protrusion 110 that protrudes towards the base cover 400, and the base cover 400 may include a cover groove 410 having a predetermined length in a circumferential direction. The cover protrusion 110 may be inserted into the cover groove 410. When the main cover 100 rotates with respect to the base cover 400, the cover protrusion 110 may move along the cover groove 410. Rotation blocking surfaces 411 may be provided in both ends of the cover groove 410. When the cover protrusion 110 abuts the rotation blocking surfaces 411, the rotation of the main cover 100 may be blocked. Accordingly, the rotational range of the main cover 100 with respect to the base cover 400 may be limited to the length of the cover groove 410.

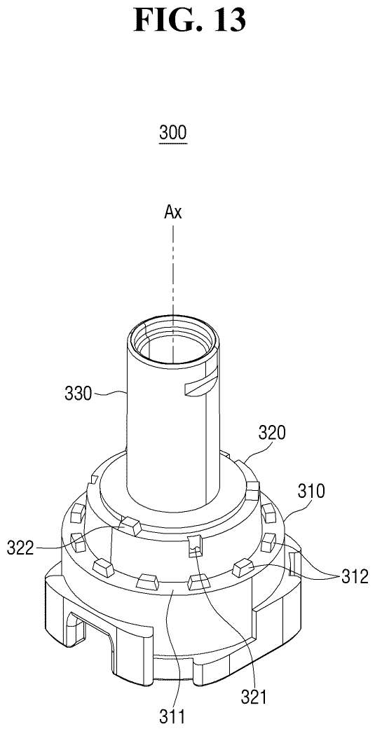

FIG. 13 is a perspective view of the fixing member 300. Referring to FIG. 13, the fixing member 300 may be formed by stacking a plurality of cylinders 310, 320, and 330 having different diameters.

The plurality of cylinders 310, 320, and 330 may include a first cylinder 310, a second cylinder 320, and a third cylinder 330. All central axes of the first cylinder 310, the second cylinder 320, and the third cylinder 330 may correspond to one another. Herein, a central axis Ax of the first cylinder 310, the second cylinder 320, and the third cylinder 330 may be the rotation axis of the mirror housing 12 with respect to the mirror base 11 or the rotation axis of the driving member 200 with respect to the fixing member 300. Hereinafter, the central axis is referred to as the rotation axis.

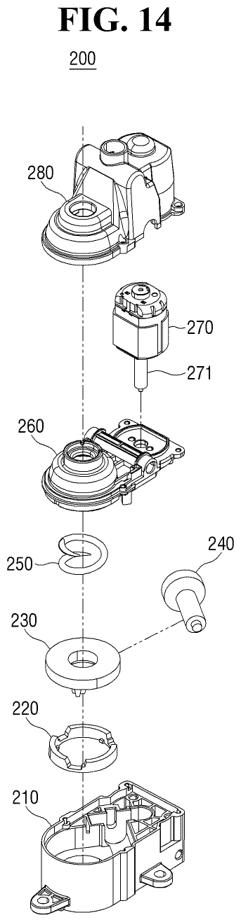

The first cylinder 310 may be coupled to a drive body 210 (see FIG. 14) of the driving member 200 and may provide the rotational reference of the drive body 210. The drive body 210 may abut an outer circumferential face of the first cylinder 310 and may rotate with respect to a rotation axis Ax.

The second cylinder 320 may be coupled to the detent member 220 (see FIG. 14) of the driving member 200 and may guide the detent member 220. The detent member 220 may abut an outer circumferential face of the second cylinder 320 and may move along the vertical (e.g., axial) direction of the second cylinder 320 parallel to the rotation axis Ax.

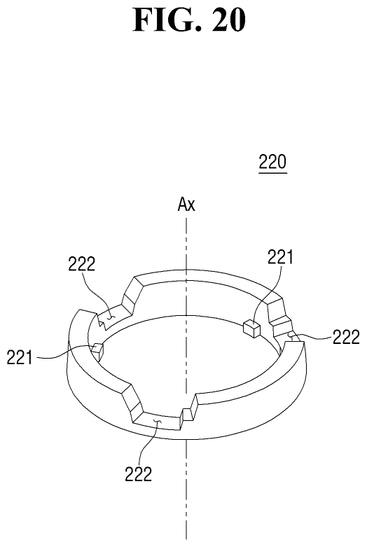

In order to provide the movement path of the detent member 220, a movement path groove 321 may be formed in the second cylinder 320. The movement path groove 321 may be formed by recessing an outer surface of the second cylinder 320 along the direction parallel to the rotation axis Ax. As described below, a movement path protrusion 221 (see FIG. 20) configured to be inserted into the movement path groove 321 may be formed in the detent member 220. The movement path protrusion 221 may be inserted into the movement path groove 321 and may be guided along the direction parallel to the rotation axis Ax. Accordingly, the detent member 220 may be allowed to move with respect to the second cylinder 320 along the axial direction and prevented from rotating with respect to the second cylinder 320.

The third cylinder 330 may be coupled to an elastic member 250 (see FIG. 14) of the driving member 200 and may fix the position of the elastic member 250. The elastic member 250 may expand or contract in the vertical direction of the third cylinder 330. In addition, the third cylinder 330 may be coupled to a driving gear 230 (see FIG. 14) of the driving member 200 and may provide a rotation reference and a movement reference of the driving gear 230. The driving gear 230 may abut an outer circumferential face of the third cylinder 330 to rotate with respect to the rotation axis Ax or move in the vertical direction of the third cylinder 330.

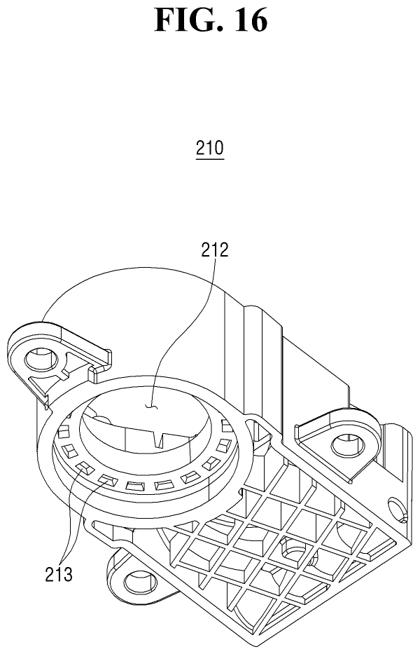

The fixing member 300 may include a ring-shaped seating surface 311 to allow the drive body 210 to be seated thereon, and the seating surface 311 may include at least one support protrusion 312 that protrudes from a surface thereof. The seating surface 311 may be formed in the first cylinder 310. For example, the seating surface 311 may be formed parallel to an imaginary surface perpendicular to the rotation axis Ax. Furthermore, the support protrusion 312 may protrude in the direction parallel to the rotation axis Ax. The support protrusion 312 may be inserted into at least one support groove 213 (see FIG. 16) of the drive body 210 described below.

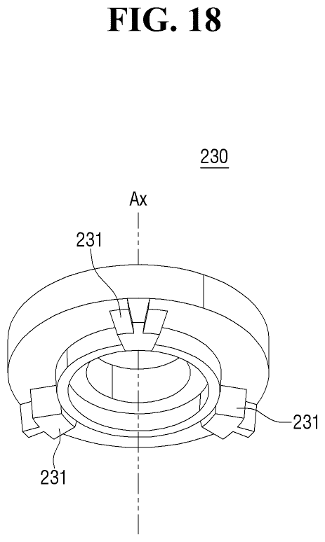

The fixing member 300 may include a rotation blocking member 322. The rotation blocking member 322 may be disposed on a rotation path of the driving gear 230 for the fixing member 300 and be in contact with a detent protrusion 231 (see FIG. 18) of the driving gear 230, thereby obstructing the rotation of the driving gear 230 with respect to the fixing member 300. Although FIG. 13 illustrates that the second cylinder 320 includes the rotation blocking member 322, in some embodiments of the present disclosure, the first cylinder 310 may include the rotation blocking member 322.

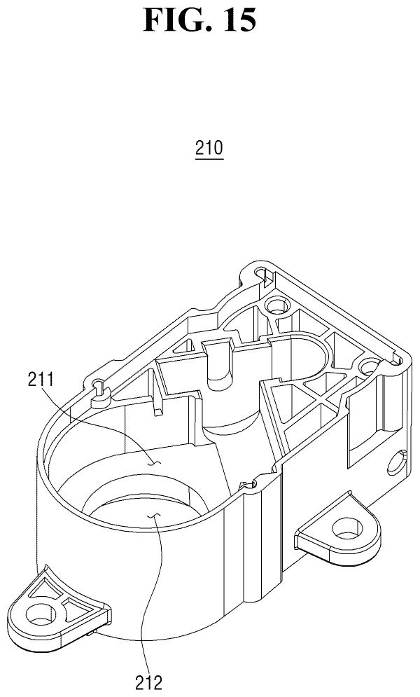

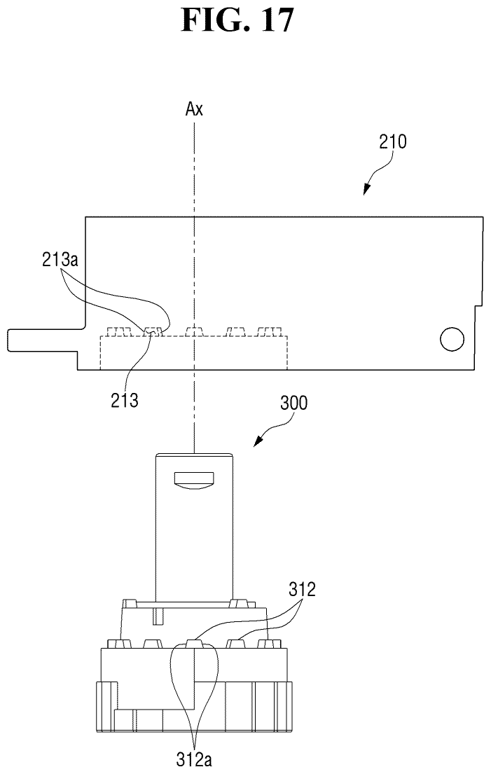

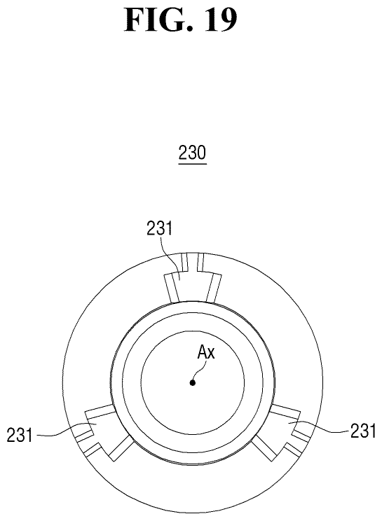

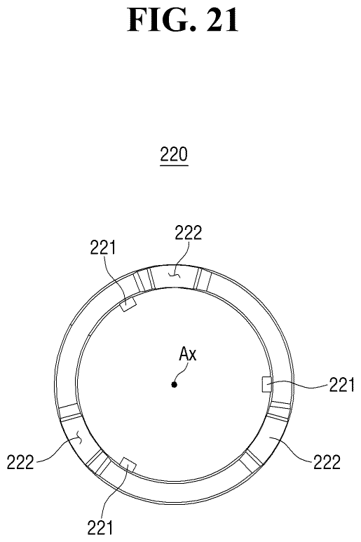

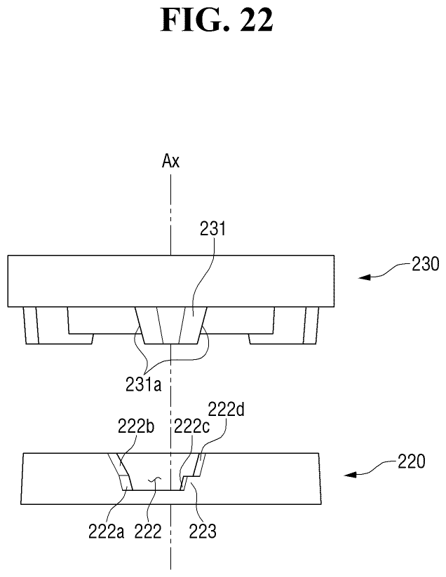

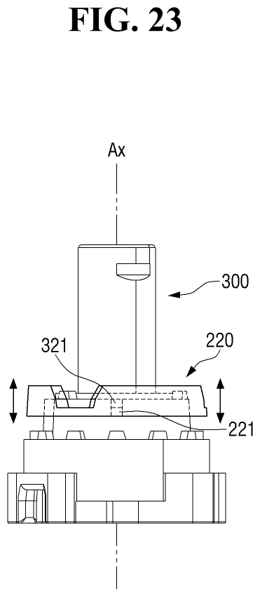

FIG. 14 is an exploded perspective view of the driving member 200, FIG. 15 is a perspective view of the drive body 210, FIG. 16 is a bottom perspective view of the drive body 210, FIG. 17 illustrates a coupling relationship between the drive body 210 and the fixing member 300, FIG. 18 is a bottom perspective view of the driving gear 230, FIG. 19 is a bottom view of the driving gear 230, FIG. 20 is a perspective view of the detent member 220, FIG. 21 is a top plan view of the detent member 220, FIG. 22 illustrates a coupling relationship between the driving gear 230 and the detent member 220, and FIG. 23 illustrates a coupling relationship between the fixing member 300 and the detent member 220.

Referring to FIG. 14, the driving member 200 may include the drive body 210, the detent member 220, the driving gear 230, a transmission gear 240, the elastic member 250, a motor support 260, a driving motor 270, and a drive cover 280.

The drive body 210 may be rotatably coupled to the fixing member 300. Accordingly, the drive body 210 may rotate with respect to the fixing member 300. The drive body 210 may be fixedly coupled to the mirror housing 12. More specifically, the drive body 210 may be fixed to the mirror housing 12 via the main cover 100.

The drive body 210 may be coupled to the drive cover 280 to provide an accommodation space for accommodating the detent member 220, the driving gear 230, the transmission gear 240, the elastic member 250, the motor support 260, and the driving motor 270. The drive body 210, the detent member 220, the driving gear 230, the transmission gear 240, the elastic member 250, the motor support 260, the driving motor 270, and the drive cover 280 may be operated as a unit.

Referring to FIGS. 15 and 16, the drive body 210 may include an accommodation space 211, a through hole 212, and a support groove 213. The detent member 220, the driving gear 230, the transmission gear 240, the elastic member 250, and the motor support 260 may be accommodated in the accommodation space 211. The third cylinder 330 of the fixing member 300 may penetrate through the through hole 212. The support protrusion 312 of the fixing member 300 may be inserted into the support groove 213. As the support protrusion 312 is inserted into the support groove 213, the positions of the drive body 210 for the fixing member 300 may be fixed.

Referring to FIG. 17, the drive body 210 may be rotatably coupled to the fixing member 300. The drive body 210 and the fixing member 300 may be coupled by stacking the drive body 210 on the fixing member 300 in the direction parallel to the rotation axis Ax.

The support groove 213 may be formed in the drive body 210, and the support protrusion 312 may be formed in the fixing member 300. The support protrusion 312 and the support groove 213 may include a support protrusion inclined surface 312a and a support groove inclined surface 213a, respectively, which face each other in the rotation direction of the drive body 210 with respect to the fixing member 300 and are inclined with respect to the longitudinal direction of the rotation axis Ax of the mirror housing 12.

When a relatively small torque is exerted on the drive body 210 with respect to the rotation axis Ax in a state where the support protrusion 312 is inserted into the support groove 213, the support protrusion 312 may remain inserted into the support groove 213, and the position of the drive body 210 with respect to the fixing member 300 may remain fixed. On the other hand, when a relatively large torque is exerted on the drive body 210 with respect to the rotation axis Ax in the state where the support protrusion 312 is inserted into the support groove 213, as the support protrusion inclined surface 312a and the support groove inclined surface 213a may be dislodged from each other, the drive body 210 may ascend along the support protrusion 310. For example, when the drive body 210 is rotated by the force of the driving motor 270, the support protrusion 312 may be dislodged from the support groove 213, and the drive body 210 may ascend along the support protrusion 312. In such case, the drive body 210 may move in the direction parallel to the rotation axis Ax by the height of the support protrusion 312 from the seating surface 311.

As described above, the fixing member 300 may be fixed to the mirror base 11, and the drive body 210 may be fixed to the mirror housing 12. When the drive body 210 moves with respect to the fixing member 300 in the direction of dislodging the support protrusion 312 from the support groove 213, a gap between the mirror base 11 and the mirror housing 12 may increase. When the position of the mirror housing 12 is changed from the first position to the second position, the gap between the mirror base 11 and the mirror housing 12 may increase as the support protrusion 312 is dislodged from the support groove 213, thus preventing the friction between the mirror base 11 and the mirror housing 12.

Herein, although the description has been given for an example where the support protrusion 312 is included in the fixing member 300 and the support groove 213 is included in the drive body 210, the present disclosure is not limited thereto. In some embodiments, the support protrusion 312 may be included in the drive body 210, and the support groove 213 may be included in the fixing member 300.

Referring to FIGS. 18 and 19, the driving gear 230 may be formed in the shape of a disk (e.g., annulus) with an aperture at the center thereof. The aperture may be penetrated by the third cylinder 330 of the fixing member 300. An inner surface of the aperture may abut the outer circumferential surface of the third cylinder 330. The driving gear 230 may rotate or move vertically while abutting the third cylinder 330.

Gear teeth may be formed on an outer circumferential surface of the driving gear 230. The driving gear 230 may be gear-coupled to the transmission gear 240 by using the gear teeth. The transmission gear 240 may transmit the driving force generated by the driving motor 270, and accordingly, the driving gear 230 may be rotated by the driving force of the driving motor 270.

The driving gear 230 may include at least one detent protrusion 231. The detent protrusion 231 may protrude from a surface of the driving gear 230. By way of example, the detent protrusion 231 may protrude downward from a bottom surface thereof, the bottom surface being perpendicular to the rotation axis Ax. The driving gear 230 may be stacked on the detent member 220 in the direction parallel to the rotation axis Ax of the mirror housing 12. When the driving gear 230 is stacked on the detent member 220, the detent protrusion 231 may be inserted into a detent groove 222 (see FIG. 22). The position of the driving gear 230 relative to the detent member 220 may be fixed by the detent protrusion 231 inserted into the detent groove 222.

The driving gear 230 may include a plurality of detent protrusions 231, all of which may be disposed so that distances between adjacent protrusions along the circumferential direction of the driving gear 230 are equal. By way of example, referring to FIG. 19, the distance between a top detent protrusion 231 and a left detent protrusion 231, the distance between the top detent protrusion 231 and a right detent protrusion 231, and the distance between the left detent protrusion 231 and the right detent protrusion 231 may be substantially equal. Here, the top, left, and right detent protrusions are designated in terms of the orientation as shown in FIG. 19 for the purpose of description, regardless of their actual positions when assembled in the driving apparatus according to an embodiment of the present disclosure.

Referring to FIGS. 20 and 21, the detent member 220 may be provided in the shape of a ring. The detent member 220 may include the movement path protrusion 221 and the detent groove 222. The movement path protrusion 221 may be inserted into the movement path groove 321 of the second cylinder 320. The movement path protrusion 221 may protrude inward from the inner circumferential side of the detent member 220.

The detent protrusion 231 of the driving gear 230 may be inserted into the detent groove 222 of the detent member 220. Accordingly, the position of the driving gear 230 relative to the detent member 220 may be fixed by the detent protrusion 231 inserted into the detent groove 222.

The detent member 220 may include a protrusion support 223 formed at a bottom corner of the detent groove 222. The protrusion support 223 may protrude inward from the detent groove 222 and may support the detent protrusion 231 in a state where the detent protrusion 231 is separated from a bottom surface of the detent groove 222 by a predetermined distance. The detent protrusion 231 may be supported by the protrusion support 223 when the driving gear 230 is rotated counterclockwise with respect to the detent member 220. Alternatively, the detent protrusion 231 may fall from the protrusion support 223 so that the detent protrusion 231 may rest on the bottom surface of the detent groove 222.

The detent member 220 may include a plurality of detent grooves 222, all of which may be disposed at positions corresponding to the plurality of detent protrusions 231. More specifically, the plurality of detent grooves 222 may be disposed so that distances between adjacent grooves are identical to one another along the circumferential direction of the detent member 220. By way of example, referring to FIG. 21, the distance between a top detent groove 222 and a left detent groove 222, the distance between the top detent groove 222 and a right detent groove 222, and the distance between the left detent groove 222 and the right detent groove 222 may be substantially equal. Here, the top, left, and right detent grooves are designated in terms of the orientation as shown in FIG. 21 for the purpose of description, regardless of their actual positions when assembled in the driving apparatus according to an embodiment of the present disclosure.

Referring to FIG. 22, the driving gear 230 and the detent member 220 may be coupled to each other by stacking the driving gear 230 on the detent member 220. When the driving gear 230 is coupled to the detent member 220, the detent protrusion 231 of the driving gear 230 may be inserted into the detent groove 222 of the detent member 220.

The detent groove 222 and the detent protrusion 231 may include detent groove inclined surfaces 222a, 222b, 222c, and 222d, and detent protrusion inclined surfaces 231a, respectively, which face each other in the rotation direction of the driving gear 230 with respect to the detent member 220 and are inclined with respect to the longitudinal direction of the rotation axis Ax of the mirror housing 12. When the driving gear 230 rotates with respect to the detent member 220, the detent protrusion inclined surfaces 231a may abut the detent groove inclined surfaces 222a, 222b, 222c, and 222d.

When the driving motor 270 generates the driving force in a state where the detent groove inclined surfaces 222a, 222b, 222c, and 222d abut the detent protrusion inclined surfaces 231a, the drive body 210 may rotate with respect to the driving gear 230. In other words, since the rotation of the driving gear 230 with respect to the fixing member 300 may be obstructed by the detent member 220, the drive body 210 may rotate with respect to the driving gear 230 instead. In this way, the position of the mirror housing 12 may be changed from the first position to the second position or may be changed from the second position to the first position.

The detent groove 222 may include the guide inclined surfaces 222a and 222b. The guide inclined surfaces 222a and 222b may include a first guide inclined surface 222a and a second guide inclined surface 222b. The first guide inclined surface 222a may be formed by a particular height from the bottom surface of the detent groove 222, and the second guide inclined surface 222b may extend from the end of the first guide inclined surface 222a to an upper surface of the detent member 220.

The rotation of the driving gear 230 with respect to the detent member 220 may be limited in a state where the detent protrusion inclined surface 231a abuts the guide inclined surfaces 222a and 222b. When the detent protrusion inclined surface 231a abuts the guide inclined surfaces 222a and 222b, the driving gear 230 may not rotate with respect to the detent member 220 even if an external torque equal to or less than a threshold value is exerted on the driving gear 230. Meanwhile, when an external torque greater than the threshold value is transmitted to the driving gear 230, the driving gear 230 may be rotated with respect to the detent member 220. In such case, as the detent protrusion inclined surface 231a are displaced from the guide inclined surfaces 222a and 222b, the detent protrusion 231 may ascend along the guide inclined surfaces 222a and 222b. When the detent protrusion 231 ascends along the guide inclined surfaces 222a and 222b, the driving gear 230 may move axially along the direction parallel to the rotation axis Ax.

In the present disclosure, an angle of the second guide inclined surface 222b with respect to the bottom surface of the detent groove 222 may exceed an angle of the first guide inclined surface 222a with respect to the bottom surface of the detent groove 222. Accordingly, a relatively greater torque is required for the detent protrusion 231 to begin ascending along the first guide inclined surface 222a. However, a relatively smaller torque may be required once the detent protrusion 231 deviates from the first guide inclined surface 222a and ascends along the second guide inclined surface 222b.

Support inclined surfaces may be provided on the opposite side of the guide inclined surfaces 222a and 222b. The support inclined surfaces may include a first support inclined surface 222c and a second support inclined surface 222d. The first support inclined surface 222c may be formed on a side surface of the protrusion support 223, and the second support inclined surface 222d may be formed to connect the upper surface of the detent member 220 to an upper surface of the protrusion support 223.

When the detent protrusion inclined surface 231a abuts the support inclined surfaces, the rotation of the driving gear 230 with respect to the detent member 220 may be limited. When the detent protrusion inclined surface 231a abuts the support inclined surface, the driving gear 230 may not rotate with respect to the detent member 220 even if an external torque equal to or less that a threshold value is exerted on the driving gear 230. Meanwhile, when the external torque, e.g., the driving force of the driving motor 270, exceeding the threshold value is transmitted to the driving gear 230, the driving gear 230 may rotate with respect to the detent member 220. In such case, the detent protrusion 231 may ascend along the support inclined surfaces while the detent protrusion inclined surface 231a is displaced from the support inclined surfaces. When the detent protrusion 231 ascends along the first support inclined surface 222c, the detent protrusion 231 may be supported by the protrusion support 223.

When the external torque continues to be exerted on the driving gear 230 while the detent protrusion 231 is supported by the protrusion support 223, the detent protrusion 231 may ascend along the second support inclined surface 222d.

Referring to FIG. 23, the detent member 220 may be coupled to the fixing member 300. The detent member 220 may be blocked from rotating in the rotation direction of the mirror housing 12 with respect to the fixing member 300, and may be coupled to the fixing member 300 so that it may move axially in the direction parallel to the rotation axis Ax of the mirror housing 12.

As described above, the movement path groove 321 may be formed in the fixing member 300, and the movement path protrusion 221 may be formed in the detent member 220. The movement path protrusion 221 may be inserted into the movement path groove 321 while the detent member 220 is stacked on the fixing member 300. The detent member 220 may be blocked from rotating with respect to the fixing member 300 in a state where the movement path protrusion 221 is inserted into the movement path groove 321.

Meanwhile, the movement path groove 321 may be elongated in the direction parallel to the rotation axis Ax. Accordingly, the movement path protrusion 221 may move in the longitudinal (e.g., axial) direction of the movement path groove 321. Within the movement range of the movement path protrusion 221 for the movement path groove 321, the detent member 220 may move in the direction parallel to the rotation axis Ax.

Referring back to FIG. 14, the transmission gear 240 may transmit the driving force of the driving motor 270 to the driving gear 230. The transmission gear 240 may be gear-coupled to a pinion gear 271 of the driving motor 270 to receive the driving force of the driving motor 270. The transmission gear 240 may be gear-coupled to the driving gear 230 and may transmit the driving force transmitted from the driving motor 270 to the driving gear 230.

The elastic member 250 may generate an elastic force against the driving gear 230 in the direction of facing the detent member 220. Accordingly, the driving gear 230 may be in contact with the detent member 220 by the elastic force of the elastic member 250.

The motor support 260 may support the driving motor 270. Since the driving motor 270 is supported by the motor support 260, the position of the driving motor 270 may be fixed to the drive body 210. The driving motor 270 may generate the driving force and rotate the drive body 210 with respect to the fixing member 300. When the drive body 210 rotates with respect to the fixing member 300, the mirror housing 12 may rotate with respect to the mirror base 11.

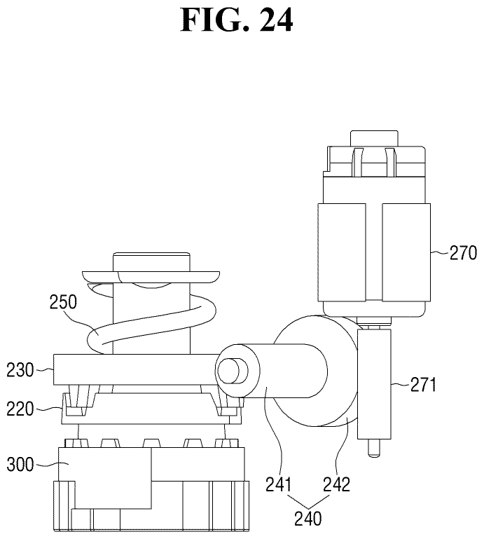

FIG. 24 depicts the driving force of the driving motor 270 being transmitted to the driving gear 230. Referring to FIG. 24, the driving force of the driving motor 270 may be transmitted to the driving gear 230 through the transmission gear 240.

The transmission gear 240 may include a first transmission gear 241 and a second transmission gear 242. The first transmission gear 241 and the second transmission gear 242 may have the same rotation axis and may be fixed to each other. The first transmission gear 241 may be provided in the form of a worm screw, while the second transmission gear 242 may be provided in the form of a worm gear.

In the present disclosure, the driving gear 230 may be provided in the form of a worm gear. In addition, the pinion gear 271 of the driving motor 270 may be provided in the form of a worm screw. Accordingly, the first transmission gear 241 may be coupled to the driving gear 230, and the second transmission gear 242 may be coupled to the pinion gear 271. The present disclosure, however, is not limited such a configuration, and depending on the orientation of the driving motor 270, a person of ordinary skill in the art may variously implement appropriate gear systems to transfer the driving force generated from the driving motor 270 to the driving gear 230.

The driving force of the driving motor 270 may be transmitted to the driving gear 230 through the pinion gear 271, the second transmission gear 242, and the first transmission gear 241. The driving gear 230 that receives the driving force may rotate with respect to the detent member 220 or may be locked to the detent member 220. When the driving gear 230 is locked to the detent member 220, a rotational force of the driving motor 270 may be used to rotate the drive body 210 with respect to the driving gear 230.

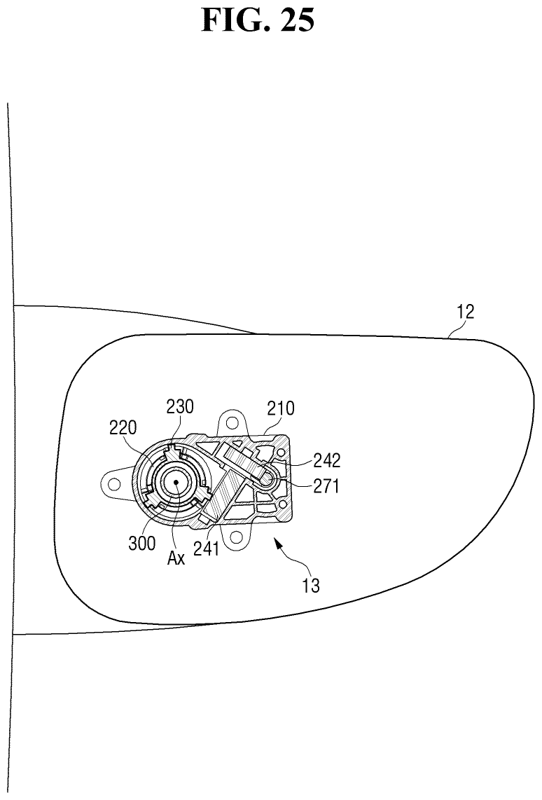

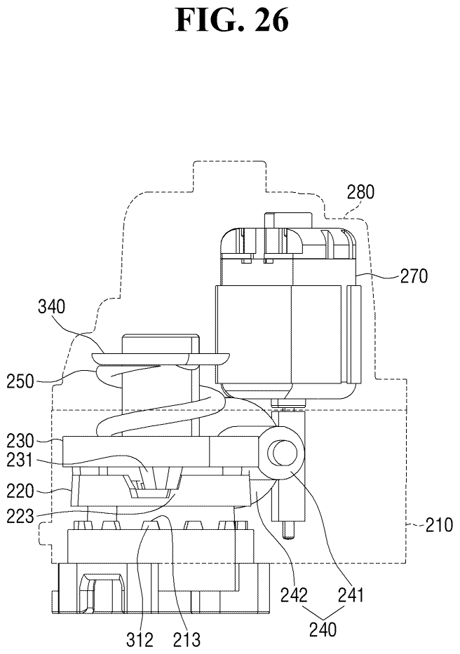

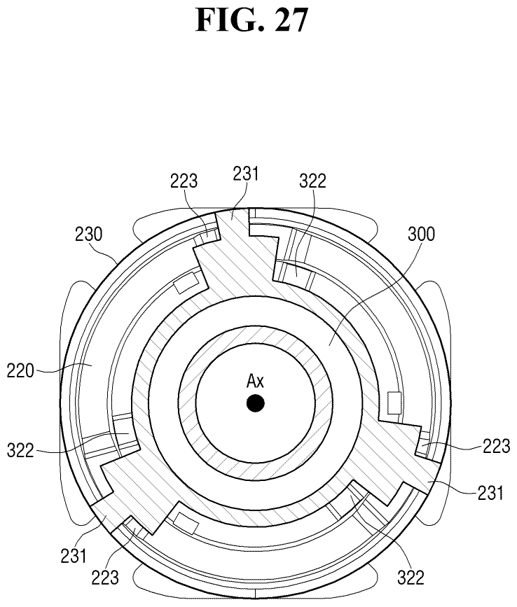

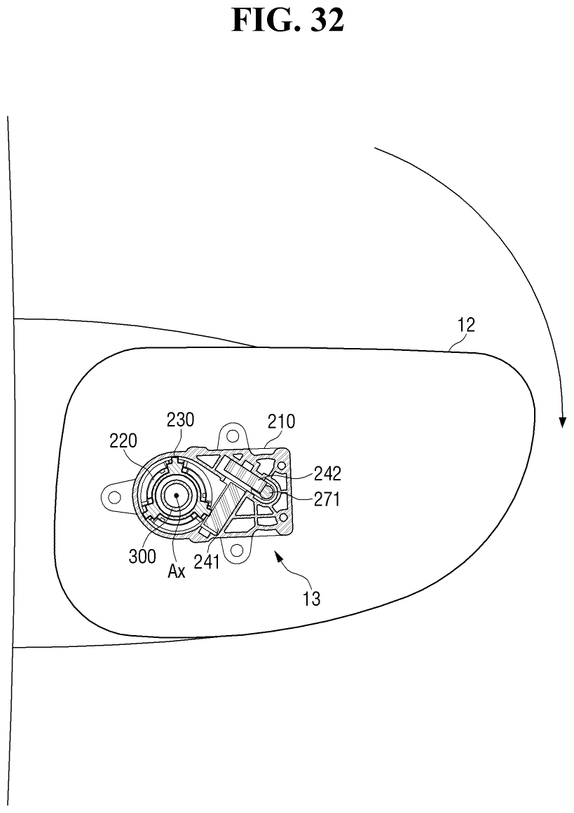

FIG. 25 depicts the first position of the mirror housing 12 with respect to the mirror base 11, FIG. 26 illustrates the inside of the driving member 200 when the mirror housing is in the first position, FIG. 27 depicts a relationship between the driving gear 230 and the detent member 220 when the mirror housing 12 is in the first position, and FIG. 32 depicts the position of the mirror housing 12 with respect to the mirror base 11 being changed from the second position to the first position.

Referring to FIGS. 25 to 27, the detent protrusion 231 of the driving gear 230 may be supported by the protrusion support 223 of the detent member 220 in the first position of the mirror housing 12. When the detent protrusion 231 is supported by the protrusion support 223, the elastic force of the elastic member 250 may be transmitted to the mirror housing 12 through the detent member 220 and the drive body 210, and thus may act as a force to maintain the mirror housing 12 proximate to the mirror base 11.

Specifically, the elastic member 250 may provide the elastic force to the driving gear 230 in a state where the elastic member 250 is supported by an elastic support 340 fixed to the fixing member 300. Accordingly, the driving gear 230 may be pressed in the direction toward the detent member 220 by the elastic force of the elastic member 250. When the detent protrusion 231 of the driving gear 230 presses the protrusion support 223, the support protrusion 312 of the fixing member 300 may be inserted into the support groove 213 of the drive body 210. In such case, the mirror housing 12 may be disposed proximate to the mirror base 11 at the preset reference interval. The first position of the mirror housing 12 may be a position of the mirror housing 12 during driving. As the mirror housing 12 is disposed proximate to the mirror base 11, the wind noise can be prevented or reduced.

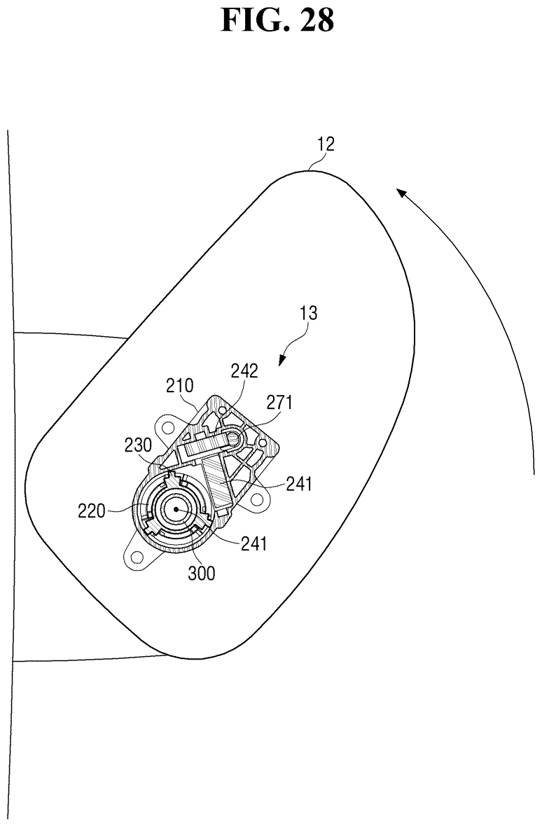

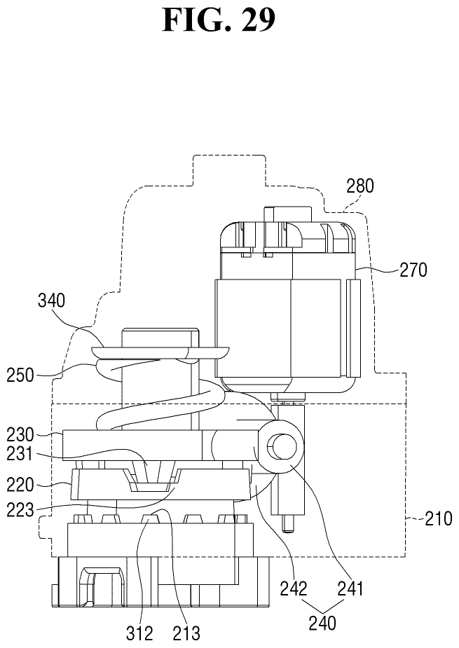

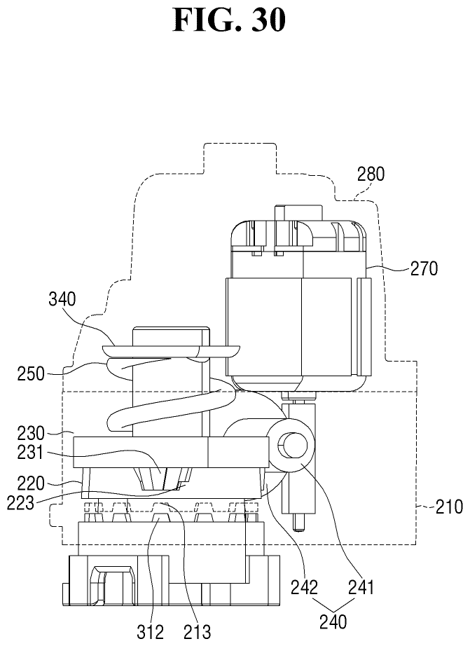

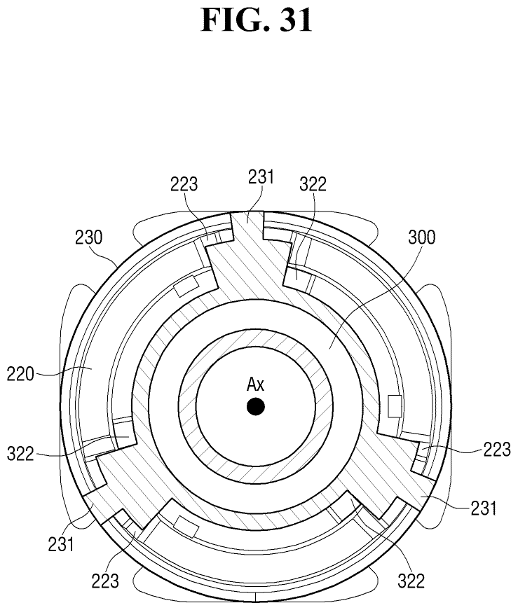

FIG. 28 depicts the position of the mirror housing 12 with respect to the mirror base 11 being changed from the first position to the second position, FIG. 29 illustrates the support of the detent protrusion 231 being released from the protrusion support 223, FIG. 30 depicts the detent protrusion 231 supported by the bottom surface of the detent groove 222, and FIG. 31 depicts the detent protrusion 231 abutting the guide inclined surface 222a and 222b and the rotation blocking member 322.

Referring to FIGS. 28 to 31, the position of the mirror housing 12 may be changed from the first position to the second position. The position change of the mirror housing 12 may be performed by the driving force of the driving motor 270. When the driving motor 270 generates the driving force, the driving gear 230 may be rotated. When the driving gear 230 rotates, as illustrated in FIG. 29, the support of the detent protrusion 231 may be released from the protrusion support 223.

With the support of the detent protrusion 231 released (e.g., having fell) from the protrusion support 223, the driving gear 230 may continue to rotate. As illustrated in FIGS. 30 and 31, the detent protrusion 231 may move while being supported by the bottom surface of the detent groove 222 and may abut the guide inclined surfaces 222a and 222b of the detent groove 222, and the rotation blocking member 322 of the fixing member 300.

In a state that the detent protrusion 231 abuts the rotation blocking member 322 and the driving gear 230 is blocked from rotating with respect to the fixing member 300, the driving force of the driving motor 270 may act as a torque that rotates the drive body 210 with respect to the driving gear 230. More specifically, while the detent protrusion 231 is in contact with the guide inclined surfaces 222a and 222b of the detent groove 222 and the rotation blocking member 322 of the fixing member 300, the driving force of the driving motor 270 may be transmitted to the driving gear 230. In such case, since the driving gear 230 is blocked from rotating with respect to the detent member 220 and the fixing member 300, the drive body 210 may rotate with respect to the driving gear 230.

When the drive body 210 rotates with respect to the driving gear 230, the support protrusion 312 of the fixing member 300 may be dislodged from the support groove 213 of the drive body 210. In other words, as the support protrusion inclined surface 312a is dislodged from the support groove inclined surface 213a, the drive body 210 may ascend along the support protrusion 312. When the drive body 210 ascends along the support protrusion 312, the distance between the mirror base 11 and the mirror housing 12 may increase. Since the mirror housing 12 rotates with respect to the mirror base 11 in a state where a predetermined distance is maintained between the mirror base 11 and the mirror housing 12, the abrasion between the mirror base 11 and the mirror housing 12 may be prevented.

In the present disclosure, the height of the protrusion support 223 from the bottom surface of the detent groove 222 may be substantially equal to or greater than the height of the support protrusion 312 from the seating surface 311 of the fixing member 300. While the support of the detent protrusion 231 is released from the protrusion support 223 and the detent protrusion 231 is supported by the bottom surface of the detent groove 222, the detent member 220 may ascend by the height of the protrusion support 223. In turn, the drive body 210 may move along the support protrusion inclined surface 312a and ascend to the top of the support protrusion 312. Since the height of the protrusion support 223 is equal to or greater than the height of the support protrusion 312, the drive body 210 and the detent member 220 may be simultaneously ascended by the corresponding height, and the driving gear 230 may maintain its position. With the maintenance of the position of the driving gear 230, the elastic force of the elastic member 250 may stay constant, and the driving gear 230 may press the detent member 220 with a constant force.

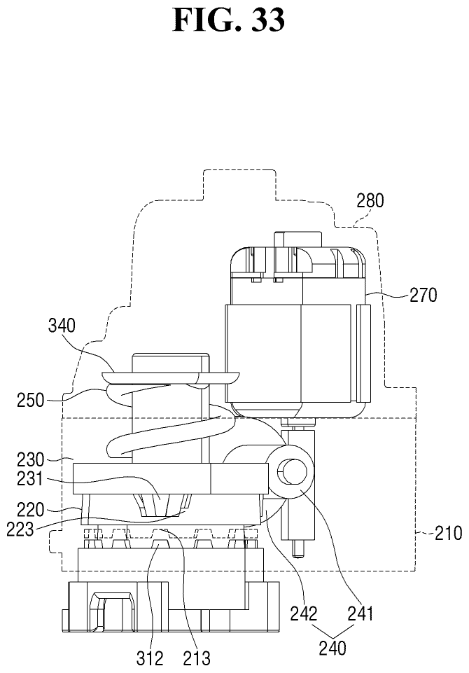

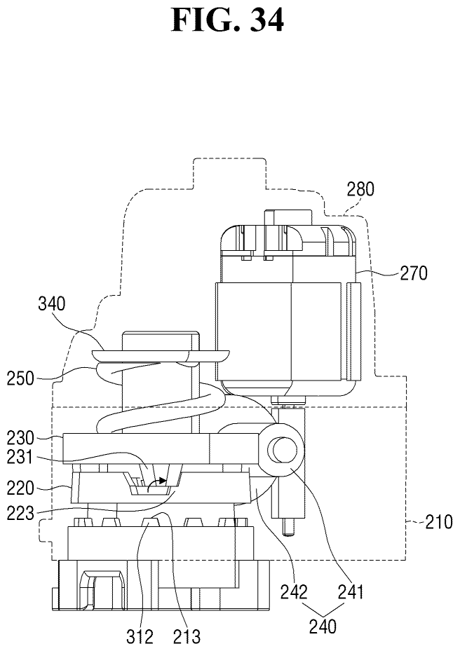

FIG. 32 depicts the position of the mirror housing 12 with respect to the mirror base 11 being changed from the second position to the first position, FIG. 33 illustrates the detent protrusion 231 abutting the support inclined surface 222c of the detent groove 222, and FIG. 34 illustrates the detent protrusion being supported by the protrusion support 223 of the detent groove 222.

Referring to FIGS. 32 to 34, the position of the mirror housing 12 may be changed from the second position to the first position. The position change of the mirror housing 12 may be performed by the driving force of the driving motor 270. When the driving motor 270 generates the driving force, the driving gear 230 may rotate. When the driving gear 230 rotates, the detent protrusion 231 of the driving gear 230 may be in contact with the first support inclined surface 222c of the detent member 220. While the detent protrusion 231 is in contact with the first support inclined surface 222c, the driving force of the driving motor 270 may be continuously transmitted to the driving gear 230. In that case, since the driving gear 230 is blocked from rotating with respect to the detent part 220, the drive body 210 may rotate with respect to the driving gear 230.

The rotation of the drive body 210 may be continued until the cover protrusion 110 of the main cover 100 abuts the rotation blocking surface 411 of the base cover 400. When the cover protrusion 110 is in contact with the rotation blocking surface 411, the drive body 210 may be blocked from rotating with respect to the mirror base 11. As the driving force of the driving motor 270 is transmitted to the driving gear 230 in this state, as illustrated in FIG. 34, the detent protrusion 231 may move along the first support inclined surface 222c and ascend to the top of the protrusion support 223, and the driving gear 230 may rotate slightly with respect to the fixing member 300. As the detent protrusion 231 ascends to an upper surface of the protrusion support 223, the position change of the mirror housing 12 to the first position may be completed.

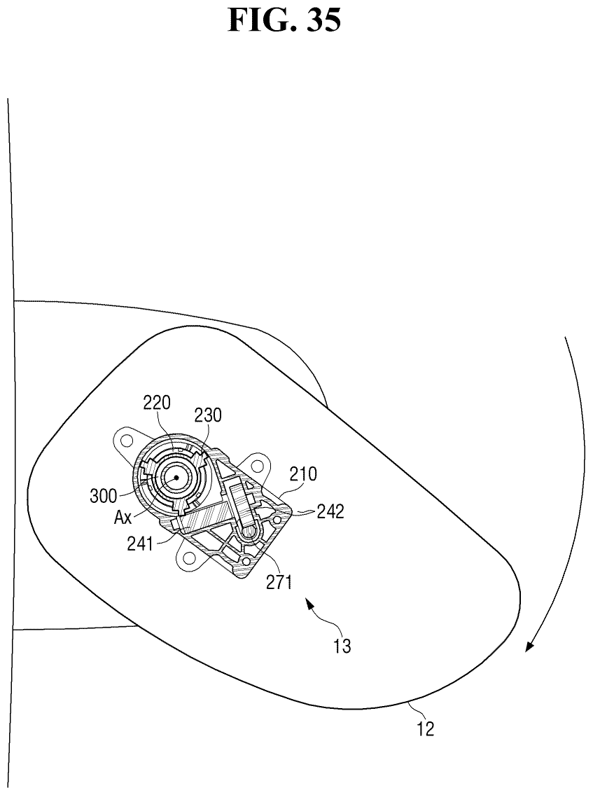

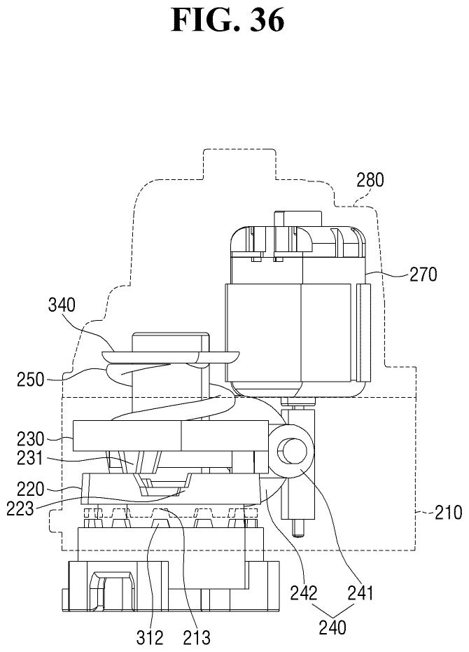

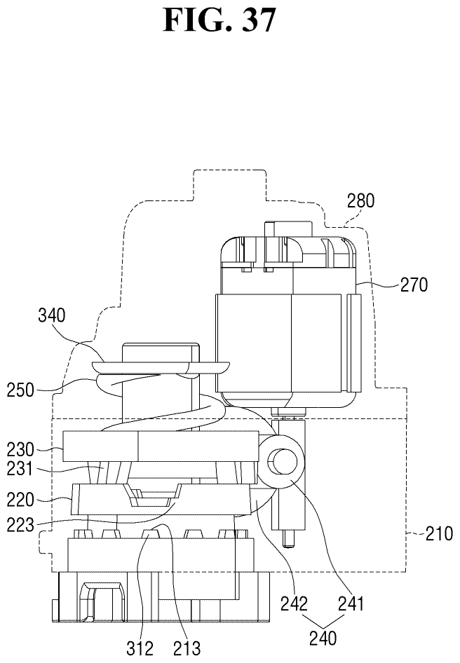

FIG. 35 depicts the position of the mirror housing 12 with respect to the mirror base 11 being changed from the first position to the third position, FIG. 36 illustrates the detent protrusion 231 moving to an upper surface of the detent member 220, and FIG. 37 illustrates the detent member 220 being pressed by the driving gear 230.

Referring to FIGS. 35 to 37, the position the mirror housing 12 may be changed from the first position to the third position. When an external force rotating the drive body 210 with respect to the fixing member 300 is exerted on the drive body 210, the driving gear 230 may rotate together with the drive body 210, and accordingly, the detent protrusion 231 may move to the upper surface of the detent member 220 along the inclined surfaces of the rotation blocking member 322 and the detent groove 222.

When pedestrians, surrounding vehicles, or surrounding objects exert the external force on the mirror housing 12, the position of the mirror housing 12 may be changed from the first position toward or to the third position as illustrated in FIG. 35. The external force exerted on the mirror housing 12 may be transmitted to the drive body 210 through the main cover 100. In such case, the external force may act as a torque that rotates the drive body 210 with respect to the rotation axis Ax.

Meanwhile, the first transmission gear 241 may be rotatably coupled to the drive body 210 based on the rotation axis thereof, and may be gear-coupled to the driving gear 230. When the drive body 210 rotates about the rotation axis Ax of the mirror housing 12, as the driving gear 230 is pushed (or pulled) by the first transmission gear 241, the driving gear 230 may rotate together with the drive body 210 due to the unidirectional characteristics of the worm screw and worm gear configuration. The external force may be transmitted to the driving gear 230 through the first transmission gear 241, thus forcing the driving gear 230 to rotate.

As illustrated in FIG. 36, as the driving gear 230 rotates, the detent protrusion 231 of the driving gear 230 may move to the upper surface of the detent member 220 while ascending along the inclined surface of the rotation blocking member 322 and the guide inclined surfaces 222a and 222b of the detent member 220. Accordingly, when the position change of the mirror housing 12 to the third position is completed, the support protrusion 312 of the fixing member 300 may be inserted into the support groove 213 of the drive body 210, and the mirror housing 12 may be simultaneously disposed close to the mirror base 11.

Meanwhile, FIGS. 35 to 37 illustrate that the position of the mirror housing 12 is changed from the first position to the third position by the external force, but when the position of the mirror housing 12 is changed from the second position to the first position by the external force, the driving apparatus 13 may operate in a manner similar thereto.

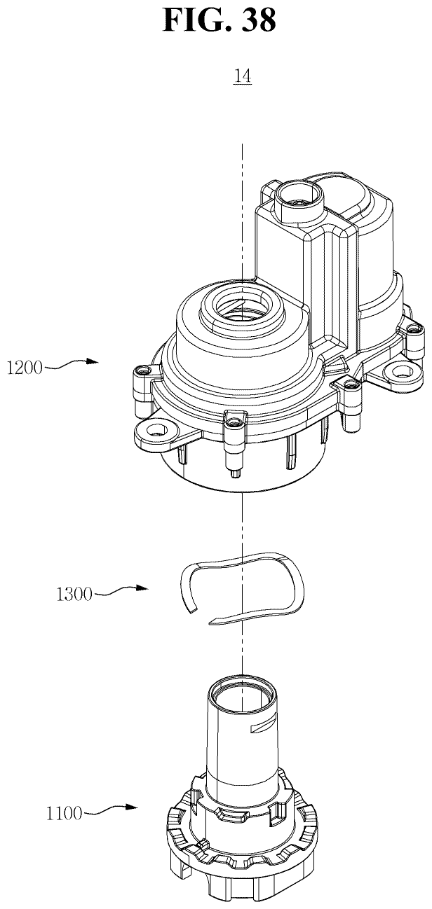

FIG. 38 is an exploded perspective view of a driving apparatus for a vehicle according to another embodiment of the present disclosure. Referring to FIG. 38, a driving apparatus 14 for a vehicle according to another embodiment of the present disclosure may include a fixing member 1100, a driving member 1200, and a base elastic member 1300.

The fixing member 1100 may be fixed to the mirror base 11 of the vehicle 10. Furthermore, the fixing member 1100 may provide a reference for the rotation of the driving member 1200. In other words, the driving member 1200 may be rotatably coupled to the fixing member 1100 and may rotate with respect to the rotation axis of the fixing member 1100.

The driving member 1200 may be fixed to the mirror housing 12 of the vehicle 10 to generate driving force and may rotate with respect to the fixing member 1100. As the driving member 1200 rotates with respect to the fixing member 1100, the mirror housing 12 may rotate with respect to the mirror base 11.

The driving member 1200 may move the mirror housing 12 proximate to the mirror base 11 at a preset reference interval when the position of the mirror housing 12 is switched from the second position to the first position. Here, the reference interval may include 0. For example, when the mirror housing 12 is in the first position, the driving member 1200 may bring the mirror housing 12 closer to the mirror base 11. As the mirror housing 12 is disposed adjacently to the mirror base 11, an occurrence of wind noise may be prevented or reduced.

The base elastic member 1300 may be provided between the fixing member 1100 and the driving member 1200 and may generate an elastic force biasing the driving member 1200 in a direction away from the fixing member 1100. Due to the base elastic member 1300, when the mirror housing 12 moves from the first position to the second position or from the second position to the first position, the driving member 1200 may be prevented from descending to the fixing member 1100. Accordingly, a state in which the mirror housing 12 is spaced apart from the mirror base 11 may be maintained.

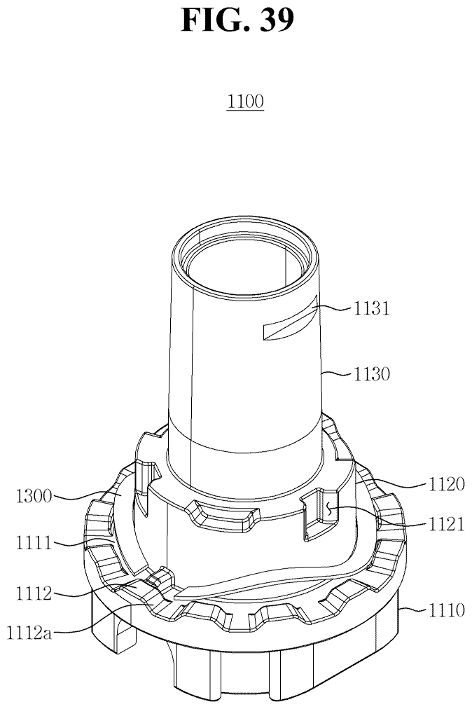

FIG. 39 depicts the base elastic member being coupled to the fixing member. Referring to FIG. 39, the fixing member 1100 may be formed by stacking a plurality of cylinders 1110, 1120 and 1130 having different diameters.

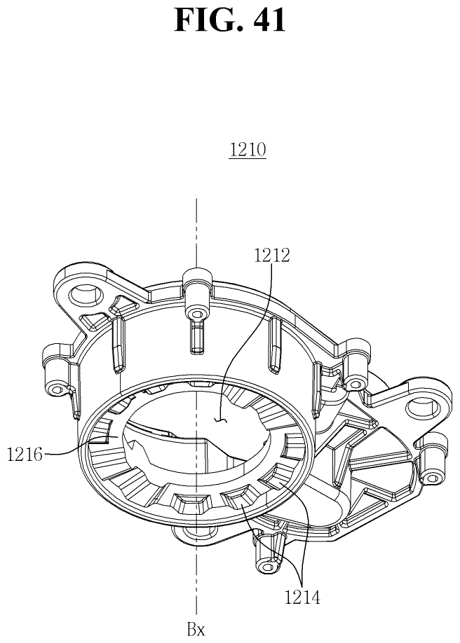

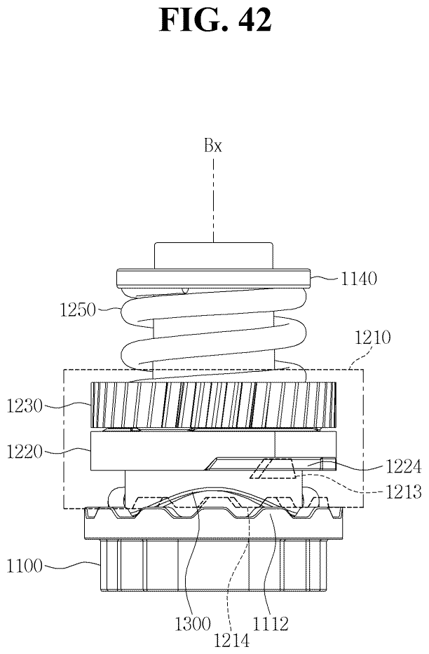

The plurality of cylinders 1110, 1120 and 1130 may include a first cylinder 1110, a second cylinder 1120, and a third cylinder 1130. Center axes of the first cylinder 1110, the second cylinder 1120, and the third cylinder 1130 may be correspond to one another. Here, a central axis Bx (see FIGS. 41 and 42) of the first cylinder 1110, the second cylinder 1120, and the third cylinder 1130 may correspond to a rotation axis of the mirror housing 12 with respect to the mirror base 11 or a rotation axis of the driving member 1200 with respect to the fixing member 1100. Accordingly, the rotation axis Bx may be herein interchangeably referred to as the above-described rotation axis.

The first cylinder 1110 may be fixedly connected to the mirror base 11. The first cylinder 1110 may include an elastic member settling surface 1111 and a fixed guide protrusion 1112. The elastic member settling surface 1111 may be formed in a direction oriented toward the driving member 1200. A plurality of fixed guide protrusions 1112 may be formed in a ring shape along an edge of the elastic member settling surface 1111. The plurality of fixed guide protrusions 1112 may be formed to protrude in a direction toward the driving member 1200. The plurality of fixed guide protrusions 1112 may be spaced apart from each other by equal intervals. A fixed guide groove may be formed between two adjacent fixed guide protrusions 1112, among the plurality of fixed guide protrusions 1112.

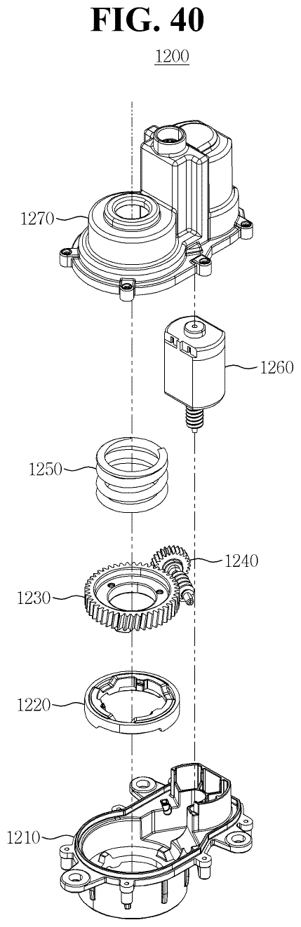

A fixed guide protrusion inclined surface 1112a may be formed at both ends of the fixed guide protrusion 1112. The fixed guide protrusion inclined surface 1112a may guide the movement of a driving guide protrusion 1214 (see FIG. 41) of the drive body 1210 (see FIG. 40) provided in the driving member 1200. When the position of the mirror housing 12 is switched between the first position and the second position, or switched between the first position and the third position, the driving guide protrusion 1214 may be guided by the fixed guide protrusion slope 1112a so that the drive body 1210 may ascend or descend with respect to the fixing member 1100.

The second cylinder 1120 may have a smaller diameter than the first cylinder 1110 and may be formed to protrude from the first cylinder 1110 toward the driving member 1200. The second cylinder 1120 may be coupled to the drive body 1210 of the driving member 1200 and may provide a reference for the rotation of the drive body 1210. The drive body 1210 may rotate with respect to the rotation axis Bx in a state in which the drive body 1210 is coupled to the second cylinder 1120.

Furthermore, the second cylinder 1120 may provide a reference for the movement of the drive body 1210 and a detent member 1220 (see FIG. 40). The drive body 1210 and the detent member 1220 may be in close contact with an outer surface of the second cylinder 1120 and may move along the rotation axis Bx.

In order to provide a movement path for the detent member 1220, a movement guide groove 1121 may be formed in the second cylinder 1120. The movement guide groove 1121 may be formed by recessing the outer surface of the second cylinder 1120. The movement guide groove 1121 may be elongated along the direction parallel with the rotation axis Bx.

The second cylinder 1120 may penetrate through the base elastic member 1300, and the base elastic member 1300 may be settled on the first cylinder 1110.

The base elastic member 1300 may be settled on the elastic member settling surface 1111. The base elastic member 1300 may include a wave spring provided in the shape of a ring. Accordingly, the base elastic member 1300 may be settled on the elastic member settling surface 1111, surrounding the second cylinder 1120. The base elastic member 1300 may exert an elastic force in an upward direction with respect to the elastic member settling surface 1111. Specifically, the base elastic member 1300 may provide an elastic force biasing to the drive body 1210 away from the fixing member 1100.

The base elastic member 1300 may be provided in the shape of a ring in which a portion thereof is cut off to include opposite ends facing each other. Accordingly, a diameter of the base elastic member 1300 may be constantly maintained regardless of a shape of the base elastic member 1300 according to a distance between the first cylinder 1110 and a bottom surface of the drive body 1210, and the coupling of the base elastic member 1300 to the second cylinder 1120 may be firmly maintained.

The third cylinder 1130 may have a smaller diameter than the second cylinder 1120 and may be formed to protrude in a direction toward the driving member 1200 from the second cylinder 1120.

A driving gear 1230 (see FIG. 40) of the driving member 1200 may be penetrated by the third cylinder 1130. The driving gear 1230 may move in a direction of the rotational axis Bx while being inserted to the third cylinder 1130.

An elastic member 1250 (see FIG. 40) of the driving member 1200 may be penetrated by the third cylinder 1130. The elastic member 1250 may be provided in a form of a coil spring, and the third cylinder 1130 may be inserted into the coil spring.

Elastic force of the elastic member 1250 may be formed in the direction of the rotation axis Bx. For example, the elastic force of the elastic member 1250 may be formed in a direction from an upper portion of the third cylinder 1130 toward the second cylinder 1120. For this purpose, the third cylinder 1130 may be provided with a support plate 1140 supporting the elastic member 1250. As the support plate 1140 supports an upper end of the elastic member 1250, the elastic force of the elastic member 1250 may be formed in the direction oriented from the upper portion of the third cylinder 1130 toward the second cylinder 1120. One side (i.e., the top end) of the elastic member 1250 may be in contact with the support plate 1140, and the other side (i.e., the bottom end) thereof may be in contact with the driving gear 1230. Accordingly, the elastic force of the elastic member 1250 may be provided to the driving gear 1230.

FIG. 40 is an exploded perspective view of the driving member 1200. Referring to FIG. 40, the driving member 1200 may include a drive body 1210, a detent member 1220, a driving gear 1230, a transmission gear 1240, an elastic member 1250, a driving motor 1260, and a drive cover 1270.

The drive body 1210 may be fixed to the mirror housing 12 and may be rotatably coupled to the fixing member 1100. In other words, the drive body 1210 may rotate with respect to the fixing member 1100.

The drive body 1210 may be coupled to the drive cover 1270 to provide an accommodation space for accommodating the detent member 1220, the driving gear 1230, the transmission gear 1240, the elastic member 1250, and the driving motor 1260. The drive body 1210 and the drive cover 1270 may be coupled to each other by a coupling means such as a screw. Accordingly, not only the drive body 1210 and the drive cover 1270, but also the detent member 1220, the driving gear 1230, the transmission gear 1240, the elastic member 1250, and the driving motor 1260 accommodated in the drive body 1210 may all operate in an integrated manner.

The detent member 1220 may be penetrated by the fixing member 1100 so that the rotation of the mirror housing 12 in a rotation direction may be blocked with respect to the fixing member 1100 and the movement of the mirror housing 12 in the direction of the rotation axis Bx may be allowed.

The driving gear 1230 may be provided in the shape of a ring and may rotate with respect to the rotation axis Bx of the mirror housing 12 by the driving force provided by the driving motor 1260. The transmission gear 1240 may transmit the driving force of the driving motor 1260 to the driving gear 1230. The driving gear 1230 and the detent member 1220 may be stacked. The elastic member 1250 may provide an elastic force to the driving gear 1230. The elastic force of the elastic member 1250 may be transmitted from the driving gear 1230 to the detent member 1220, and may be transmitted from the detent member 1220 to the drive body 1210.

The driving motor 1260 may generate a driving force to rotate the drive body 1210 with respect to the fixing member 1100. With the rotation of the drive body 1210, an entire driving member 1200 may be rotated with respect to the fixing member 1100.

FIG. 41 is a bottom perspective view of a drive body. Referring to FIG. 41, the drive body 1210 may include a through-hole 1212, an elastic member contact surface 1216, and a driving guide protrusion 1214.

The through-hole 1212 may be penetrated by the second cylinder 1120 of the fixing member 1100. The drive body 1210 may rotate with respect to the rotation axis Bx in a state in which the drive body 1210 is settled on the first cylinder 1110 of the fixing member 1100.

The elastic member contact surface 1216 may be in contact with the base elastic member 1300. The drive body 1210 may receive an elastic force from the base elastic member 1300 through the elastic member contact surface 1216.

A plurality of driving guide protrusions 1214 may be formed in a ring shape along an edge of the elastic member contact surface 1216. As described above, the fixing member 1100 may include the fixed guide protrusion 1112 and the fixed guide groove. When the mirror housing 12 is in the first position, each of the plurality of driving guide protrusions 1214 may be inserted into the fixed guide groove formed between adjacent fixed guide protrusions 1112, among the plurality of fixed guide protrusions 1112. Furthermore, when the mirror housing 12 is in the second position, each of the plurality of driving guide protrusions 1214 may be released from the corresponding fixed guide groove.

Meanwhile, the base elastic member 1300 may be provided between the fixing member 1100 and the drive body 1210. When the position of the mirror housing 12 is switched from the second position to the first position, an approach of the drive body 1210 to the fixing member 1100 may be restricted by the base elastic member 1300, so that each of the plurality of driving guide protrusions 1214 may be prevented from being inserted into the corresponding fixed guide groove. Accordingly, when the position of the mirror housing 12 is switched from the second position to the first position, the drive body 1210 may be prevented from descending toward the fixing member 1100 due to gravity.

FIG. 42 depicts the interior of a driving member when a mirror housing is in the second position. Referring to FIG. 42, when the mirror housing 12 is in the second position, the drive body 1210 may be spaced apart from the fixing member 1100 by a certain distance.

When the mirror housing 12 is in the second position, the driving guide protrusion 1214 of the drive body 1210 may be released from the fixed guide groove formed between the fixed guide protrusions 1112, and a detent guide protrusion 1213 may be inserted into the detent guide groove 1224 of the detent member 1220.

The driving gear 1230 and the detent member 1220 may be stacked. The elastic member 1250 may provide an elastic force to the driving gear 1230. The elastic force of the elastic member 1250 may be transmitted from the driving gear 1230 to the detent member 1220, and may be transmitted from the detent member 1220 to the drive body 1210.

The base elastic member 1300 may be provided between the fixing member 1100 and the drive body 1210. The base elastic member 1300 may exert a force biasing the drive body 1210 in the upward direction. The drive body 1210 may thus be prevented from descending, and a gap between the fixing member 1100 and the drive body 1210 may be maintained.

Herein, the driving apparatus according to the present disclosure has been described for one of the side mirrors of the vehicle. However, a person of ordinary skill in the art will understand that the driving apparatus for the other side mirror may be similarly implemented primarily as a mirror image of the embodiments described throughout the specification.

Although the embodiments of the present disclosure have been described above with reference to the accompanying drawings, the present disclosure is not limited to the disclosed embodiments, but may be implemented in various different ways, and the present disclosure may be embodied in many different forms without changing technical subject matters and essential features as will be understood by those skilled in the art. Therefore, embodiments set forth herein are exemplary only and not to be construed as limiting.

What is claimed is:

1. An apparatus for operating a mirror assembly of a vehicle, comprising:
a fixing member fixed to a mirror base of the vehicle;
a driving member fixed to a mirror housing of the vehicle and configured to generate a driving force to rotate the mirror housing with respect to the fixing member; and
a base elastic member disposed between the fixing member and the driving member to generate an elastic force that biases the driving member away from the fixing member,
wherein a position of the mirror housing is switchable to a first position in which the mirror housing is unfolded with respect to the mirror base or to a second position in which the mirror housing is folded with respect to the mirror base, and
wherein the driving member is configured to:
decrease a gap between the mirror housing and the mirror base in response to the mirror housing having been switched to the first position; and
increase the gap in response to the mirror housing being switched from the first position to the second position.

2. The apparatus of claim 1, wherein the base elastic member includes a wave spring provided in a ring shape.

3. The apparatus of claim 2, wherein the fixing member comprises:
a first cylinder having a first diameter; and
a second cylinder that has a second diameter smaller than the first diameter and protrudes from the first cylinder, and
wherein the base elastic member is configured to be settled on the first cylinder by being penetrated by the second cylinder.

4. The apparatus of claim 3, wherein the first cylinder includes:
an elastic member settling surface on which the base elastic member is configured to be settled;
a plurality of fixed guide protrusions formed to protrude along an edge of the elastic member settling surface; and
a plurality of fixed guide grooves, each of which is formed between adjacent fixed guide protrusions among the plurality of fixed guide protrusions.

5. The apparatus of claim 4, wherein the driving member includes a drive body fixed to the mirror housing and rotatably coupled to the fixing member, and
wherein the drive body comprises:
an elastic member contact surface configured to abut the base elastic member; and
a plurality of driving guide protrusions formed to protrude along an edge of the elastic member contact surface.

6. The apparatus of claim 5, wherein, when the mirror housing is in the first position, the plurality of driving guide protrusions are inserted into the plurality of fixed guide grooves, and
wherein, when the mirror housing is in the second position, the plurality of driving guide protrusions are released from the plurality of fixed guide grooves.

7. The apparatus of claim 5, wherein, while the position of the mirror housing is switched from the second position to the first position, an approach of the drive body to the fixing member is restricted by the base elastic member, so that the plurality of driving guide protrusions are prevented from being inserted into the plurality of fixed guide grooves.

8. The apparatus of claim 5, wherein the driving member includes a detent member that is penetrated by the fixing member so that a rotation of the mirror housing in a rotation direction is blocked with respect to the fixing member and a movement of the mirror housing in a direction of a rotation axis is allowed,
wherein the detent member includes a detent reference surface facing the drive body and a detent guide groove formed by recessing an edge of the detent reference surface in a shape of an arc, and
wherein the drive body includes a driving reference surface facing the detent member and a detent guide protrusion formed to protrude from the driving reference surface.

9. The apparatus of claim 8, wherein, when the mirror housing is in the first position, the detent guide protrusion is spaced apart from the detent guide groove by a predetermined interval, and
wherein, when the mirror housing is in the second position, the detent guide protrusion is inserted into the detent guide groove.

10. The apparatus of claim 8, wherein the detent guide groove includes a detent guide groove inclination surface that is inclined with respect to a direction of a rotation axis of the mirror housing.

11. The apparatus of claim 10, wherein, when the position of the mirror housing is switched from the second position to the first position, the detent guide protrusion is guided by the detent guide groove inclination surface, and the drive body approaches the fixing member, so that the plurality of driving guide protrusions are inserted into the plurality of fixed guide grooves.

12. The apparatus of claim 10, wherein the detent guide protrusion includes a detent guide protrusion inclination surface formed to abut the detent guide groove inclination surface.

13. The apparatus of claim 8, wherein the position of the mirror housing is switchable to a third position in which the mirror housing is folded in a direction opposite to a direction in which the mirror housing is switched from the first position to the second position,
wherein a plurality of detent guide grooves are provided in the detent member, and
wherein a range of an angular change of the mirror housing due to a position switch between the first position and the third position is included in a range of an angular interval between adjacent detent guide grooves, among the plurality of detent guide grooves.

14. The apparatus of claim 8, wherein a plurality of detent guide protrusions are provided at substantially equal angular intervals with respect to a rotation axis of the mirror housing.

15. The apparatus of claim 2, wherein the base elastic member is provided in an open ring shape in which a portion thereof is cut off to allow opposite ends to face each other.
